(19) United States
(12) Patent Application Publication
(10) Pub. No.: US 2026/0003046 A1
(43) Pub. Date: Jan. 1, 2026

(54) METHOD, APPARATUS, CONTROLLER, AND PRODUCT FOR DETERMINING CALIBRATION PARAMETERS OF A SENSOR

(71) Applicant: Robert Bosch GmbH, Stuttgart (DE)

(72) Inventor: Chun Li, Shanghai (CN)

(21) Appl. No.: 19/252,293

(22) Filed: Jun. 27, 2025

(30) Foreign Application Priority Data
Jun. 28, 2024 (CN) 2024 1085 6573.8

(51) Int. Cl. G01S 7/497; G01S 17/08; G01S 17/86

(52) U.S. Cl. CPC G01S 7/497; G01S 17/08; G01S 17/86

(57) ABSTRACT

A method, an apparatus, a controller, and a computer program product for determining calibration parameters of a sensor are disclosed. The method includes (i) determining odometer data of multiple first sensors based on data of the multiple first sensors, and (ii) determining calibration parameters of multiple first sensors and a second sensor based on the odometer data of the multiple first sensors and data of the second sensor, wherein the first sensor and the second sensor are sensors of different types. This approach enables the simultaneous calibration of multiple mixed-type sensors, resulting in time savings and enhanced accuracy and consistency of the data collected from these sensors.

This application claims priority under 35 U.S.C. § 119 to application no. CN 2024 1085 6573.8, filed on Jun. 28, 2024 in China, the disclosure of which is incorporated herein by reference in its entirety.

The present disclosure relates to the field of sensor technology, and more specifically, to a method, a device, an apparatus, and a computer program product for determining calibration parameters of a sensor.

### BACKGROUND

Sensor technology plays a key role in enabling intelligent and automated systems. Whether in process control for industrial production or in smart devices for daily life, all these applications depend on high-quality sensors to obtain accurate information. To enhance the accuracy of sensor measurements, sensors with superior performance can be selected, thorough calibration can be conducted, the installation and operating environment can be optimized, appropriate signal processing and filtering techniques can be employed to minimize interference, and the measurement data can be verified and corrected.

In addition to improving the accuracy of sensor measurements, sensor calibration can establish a unified metric for sensor output, optimize potential performance issues, adapt to different environments, enhance the reliability of measurement results, and facilitate the integration of sensors with other system components. Sensors typically require calibration through experiments after manufacturing and installation to ensure they meet design specifications and maintain the accuracy of the measured values.

### SUMMARY

Examples of the present disclosure provide a method, an apparatus, a device, and a computer program product for determining calibration parameters of a sensor.

In a first aspect of the present disclosure, a method for determining calibration parameters of a sensor is provided. The method comprises determining odometer data of multiple first sensors based on data of the multiple first sensors. The method further comprises determining calibration parameters of multiple first sensors and a second sensor based on the odometer data of the multiple first sensors and data of the second sensor, wherein the first sensor and the second sensor are sensors of different types.

In a second aspect of the present disclosure, an apparatus for determining calibration parameters of a sensor is provided. The apparatus comprises an odometer data determination unit configured to determine odometer data of multiple first sensors based on data of the multiple first sensors. The apparatus also comprises a calibration parameter determination unit configured to determine calibration parameters of multiple first sensors and a second sensor based on odometer data of the multiple first sensors and data of the second sensor, wherein the first sensor and the second sensor are sensors of different types.

In a third aspect of the present disclosure, a controller is provided. The controller comprises one or more processors; and a storage device for storing one or more programs, that, when executed by the one or more processors, enable the one or more processors to implement a method for determining calibration parameters of a sensor. The method comprises determining odometer data of multiple first sensors based on data of the multiple first sensors. The method further comprises determining calibration parameters of multiple first sensors and a second sensor based on the odometer data of the multiple first sensors and data of the second sensor, wherein the first sensor and the second sensor are sensors of different types.

In a fourth aspect of the present disclosure, a computer program product is provided. The computer program product is tangibly stored on a non-transitory computer readable medium and comprises machine executable instructions that, when executed, cause a machine to implement a method for determining calibration parameters of a sensor. The method comprises determining odometer data of multiple first sensors based on data of the multiple first sensors. The method further comprises determining calibration parameters of multiple first sensors and a second sensor based on the odometer data of the multiple first sensors and data of the second sensor, wherein the first sensor and the second sensor are sensors of different types.

It will be understood that the content described in the Summary is not intended to limit key or important features of the examples of the present disclosure, nor is it intended to limit the scope of the present disclosure. Other features of the present disclosure will become readily understood by the following description.

### BRIEF DESCRIPTION OF THE DRAWINGS

Above and other features, advantages and aspects of various examples of the present disclosure will become more apparent in combination with the accompanying drawings and with reference to the following detailed description. In the accompanying drawings, like or similar accompanying drawings designate like or similar elements, wherein:

FIG. 1 is a schematic diagram of an example environment in which some examples of the present disclosure may be implemented;

FIG. 2 is a flow chart of a method for determining calibration parameters of a sensor according to some examples of the present disclosure;

FIG. 3 is a schematic diagram of an example of determining calibration parameters of a sensor according to some examples of the present disclosure;

FIG. 4 is a schematic diagram of an apparatus for determining calibration parameters of a sensor according to some examples of the present disclosure;

FIG. 5 is a schematic diagram of a controller according to some examples of the present disclosure.

In all figures, like or similar reference signs represent like or similar elements.

### DETAILED DESCRIPTION

The examples of the present disclosure will be described in further detail below with reference to the accompanying drawings. While certain examples of the present disclosure are shown in the accompanying drawings, it should be understood that the present disclosure may be implemented in various forms and should not be construed as being limited to the examples set forth herein, rather these examples are provided for a more thorough and complete understanding of the present disclosure. It should be understood that the accompanying drawings and examples of the present disclosure are for exemplary purposes only and are not intended to limit the scope of protection of the present disclosure.

In the description of the examples of the present disclosure, the term “comprise” and other similar expressions should be understood as open-ended inclusion, that is, “comprising but not limited to”. The term “based on” should be understood as “at least partially based on”. The term “one example” or “this example” should be understood as “at least one example”. The terms “first”, “second”, etc. may refer to different or the same object. Although the terms “first”, “second”, etc. may be used herein to describe various elements, these elements should not be limited by these terms. These terms are used to distinguish one element from another. For example, a first element may be referred to as a second element, and similarly, a second element may be referred to as a first element without departing from the scope of the examples.

As used herein, unless expressly stated otherwise, the term “or” encompasses all possible combinations unless not feasible. For example, if a component is described as comprising A or B, then unless expressly stated otherwise or not feasible, the component may comprise A, or B, or A and B. As a second example, if a component is described as comprising A, B, or C, then unless expressly stated otherwise or not feasible, the component may comprise A, or B, or C, or A and B, or A and C, or B and C, or A, B, and C.

As mentioned above, once the sensor is installed on a carrier (e.g., a car, robot, aircraft, etc.), it needs to be calibrated. In addition, during the driving (movement) process of the carrier, factors such as vibration can cause the sensor's position to deviate from its original location, necessitating regular recalibration of the sensor. Therefore, sensor calibration technology can be divided into two categories: static calibration and dynamic calibration. Static calibration is performed when the sensor is in a stationary state, mainly to calibrate its basic parameters such as position, angle, zero point, etc. Dynamic calibration is performed when the sensor is in operation, allowing for a comprehensive evaluation and adjustment of its performance parameters by simulating real working scenarios. The accuracy of sensor calibration determines the perception performance and is the basis of all perception tasks. For example, self-driving cars and robots utilize multiple types of sensors working simultaneously for environmental- and self-perception. In this perception process of self-driving cars, robots, etc., the stability and accuracy of the sensors are particularly crucial.

In some correlation technologies for calibrating multi-sensor extrinsic parameters (primarily describing the position and posture of the sensors relative to an external reference coordinate system), a sequential calibration method is employed to perform extrinsic parameter calibration on multiple sensors. That is, the method involves calibrating multiple sensors in pairs. For example, sensor A and sensor B are calibrated first, then sensor A and sensor C are calibrated, and finally sensor B and sensor C are calibrated. Since there are errors in each calibration, the accumulated errors of multiple calibrations make it impossible to accurately determine the relative positions between multiple sensors, which makes the calibration process time-consuming and unable to integrate spatial data consistently. In addition, these correlation technologies usually require a static calibration environment and target board, and it is difficult to deal with the drift of calibration over time, which limits their applicability in dynamic real-world scenarios. Moreover, correlation calibration technologies are usually limited to specific types of lidar, which reduces their versatility. In addition, correlation calibration technologies face challenges in simultaneously calibrating temporal and spatial extrinsic parameters, which further increases the time required for sensor calibration.

In addition to the aforementioned limitations, when performing extrinsic calibration for multiple lidars in multiple sensors, the correlation calibration technologies require objects within the common field of view to solve the extrinsic optimization equation and obtain the extrinsic parameters. For multiple lidars with narrow overlapping fields of view, using a target calibration plate often makes the correlation calibration method ineffective.

To this end, examples of the present disclosure proposes a scheme for determining calibration parameters for a sensor. In the examples of the present disclosure, the scheme can determine odometer data of multiple first sensors based on data of the multiple first sensor. The scheme further comprising determining calibration parameters of multiple first sensors and a second sensor based on odometer data of the multiple first sensors and data of the second sensor for use in downstream tasks.

This approach enables the simultaneous calibration of multiple mixed-type sensors, resulting in time savings and enhanced accuracy and consistency of the data collected from these sensors. Moreover, by utilizing odometer data, the issue of ineffective extrinsic calibration caused by the narrow overlapping fields of view among multiple lidars in multiple sensors to be calibrated is avoided.

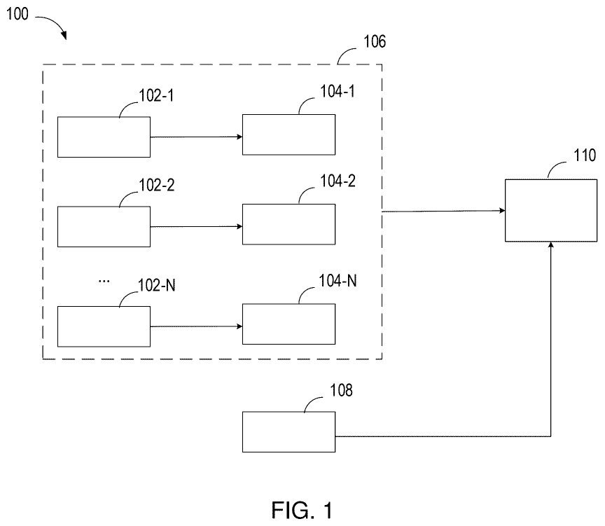

FIG. 1 is a schematic diagram of an example environment 100 in which some examples of the present disclosure may be implemented. As shown in FIG. 1, the environment 100 includes a first sensor data module 106, a second sensor 108, and a calibration parameter determination module 110. In the environment 100, the first sensor data module 106 comprises multiple first sensors (102-1, 102-2, . . . , 102-N) of the same type and multiple odometers (104-1, 104-2, . . . , 104-N) of the same type. Although multiple first sensors are shown in the drawings, this does not limit the number of first sensors. The number of first sensors may be one or two.

In FIG. 1, the first sensor 102 and the second sensor 108 are sensors of different types, where the sensor may be a long-range radar, a camera, a lidar, an ultrasonic sensor, a GPS or an IMU, etc. The odometer 104 may be a method or apparatus that uses data obtained from a mobile sensor to estimate the change of an object's position over time, which may be a long-range radar odometer, a camera odometer, a lidar odometer, an ultrasonic sensor odometer, a GPS odometer or an IMU odometer, etc.

In the first sensor data module 106, data from each first sensor 102 of the multiple first sensors (102-1, 102-2, . . . , 102-N) is transmitted to an odometer 104 of the multiple odometers (104-1, 104-2, . . . , 104-N) corresponding to the first sensor 102. For example, data from the first sensor 102-1 is transmitted to the odometer 104-1, data from the first sensor 102-2 is transmitted to the odometer 104-2, and data from the first sensor 102-N is transmitted to the odometer 104-N.

Upon receiving data from the multiple first sensors (102-1, 102-2, . . . , 102-N), the multiple odometers (104-1, 104-2, . . . , 104-N) calculate the odometer data of the multiple first sensors (102-1, 102-2, . . . , 102-N) based on the data. The odometer data of the multiple first sensors (102-1, 102-2, . . . , 102-N) may comprise position data (e.g., coordinates of the first sensor 102 in three-dimensional space), velocity data (e.g., linear velocity and angular velocity of the first sensor 102), posture data (describing posture and orientation, such as pitch angle, roll angle, yaw angle, etc. of the first sensor 102), displacement data (e.g., information such as the distance and direction moved by the first sensor 102 within a certain period of time), timestamp data (recording the specific time of each data collection point for time series analysis and processing), etc.

In the environment 100, odometer data of the multiple first sensors (102-1, 102-2, . . . , 102-N) are transmitted from the first sensor data module 106 to the calibration parameter determination module 110, and data from the second sensor 108 are transmitted to the calibration parameter determination module 110. Based on the odometer data of the multiple first sensors (102-1, 102-2, . . . , 102-N) and the data of the second sensor 108, the calibration parameter determination module 110 calculates calibration parameters of the multiple first sensors (102-1, 102-2, . . . , 102-N) and the second sensor 108, respectively. The calibration parameters may comprise multiple translation vectors (describing translation in the three directions of x, y, and z) of the multiple first sensors (102-1, 102-2, . . . , 102-N) converted to the coordinate system of the second sensor 108, multiple rotation matrices (which may be represented in the form of Euler angles or quaternions, etc.) of the multiple first sensors (102-1, 102-2, . . . , 102-N) converted to the coordinate system of the second sensor 108, calibration parameters related to the second sensor 108, the time offset of the second sensor 108 relative to the multiple first sensors (102-1, 102-2, . . . , 102-N) (the multiple first sensors [102-1, 102-2, . . . , 102-N] are time synchronized with each other and there is no time offset), and a gravity vector.

In this way, the odometer data of the multiple first sensors (102-1, 102-2, . . . , 102-N) are calculated by the multiple odometers (104-1, 104-2, . . . , 104-N), and the calibration parameters of the multiple first sensors (102-1, 102-2, . . . , 102-N) and the second sensor 108 are calculated by the calibration parameter determination module 110 based on the odometer data of the multiple first sensors (102-1, 102-2, . . . , 102-N) and the data of the second sensor 108, thereby realizing the simultaneous calibration of multiple mixed-type sensors. This approach not only shortens the time required for the calibration process, but also improves the accuracy and consistency of the data obtained from the multiple sensors. In addition, since the time offset of the second sensor 108 relative to the multiple first sensors (102-1, 102-2, . . . , 102-N) is also determined, the issue of not being able to calibrate temporal and spatial extrinsic parameters at the same time is overcome, and the calibration time is saved.

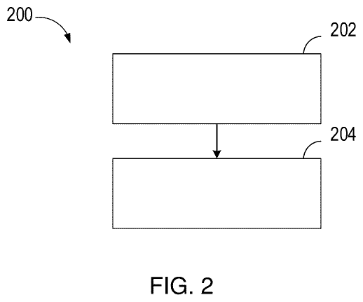

FIG. 2 is a flow chart of a method 200 for determining calibration parameters of a sensor according to some examples of the present disclosure. In some examples, the method 200 may be performed in the exemplary environment 100 described in FIG. 1. The method 200 may further comprise additional actions not shown and/or actions that may be omitted as shown, the scope of the present disclosure being not limited in this regard.

In block 202, the method 200 may determine odometer data of multiple first sensors based on data of the multiple first sensors. For example, in the environment 100 shown in FIG. 1, multiple odometers (104-1, 104-2, . . . , 104N) determine odometer data of multiple first sensors (102-1, 102-2, . . . , 102-N) based on data from multiple first sensors (102-1, 102-2, . . . , 102N).

In some examples, multiple first sensors (102-1, 102-2, . . . , 102-N) are multiple lidars, which calculate the distance between the lidar and the target object by emitting a laser beam to the surroundings and measuring the time from when the laser beam is emitted to when it is reflected back by the target object and received. As the laser beam is continuously scanned and measured, a series of point cloud data can be obtained.

In some examples, the data of multiple first sensors (102-1, 102-2, . . . , 102-N) are point cloud data scanned by multiple lidars at different times, and these point cloud data comprise three-dimensional coordinate information for determining the position and shape of the object, reflection intensity information reflecting the intensity of the laser beam reflected after irradiating the surface of the object, and time information recording the time point when each point is measured.

In some examples, the multiple odometers (104-1, 104-2, . . . , 104-N) are lidar odometers, which analyze and process the data scanned by the lidar to determine the displacement, direction angle and other information of the carrier relative to a certain initial position at different times. The odometer data of the multiple first sensors (102-1, 102-2, . . . , 102-N) comprises angular velocity, acceleration and angular acceleration of the lidar.

At block 204, the method 200 may determine calibration parameters of multiple first sensors and a second sensor based on the odometer data of the multiple first sensors and data of the second sensor, wherein the first sensor and the second sensor are sensors of different types. For example, in the environment 100 shown in FIG. 1, the calibration parameter determination module 110 calculates calibration parameters of multiple first sensors (102-1, 102-2, . . . , 102-N) and the second sensor 108 based on the odometer data of multiple first sensors (102-1, 102-2, . . . , 102-N) from the first sensor data module 106 and the data from the second sensor 108.

In some examples, the second sensor 108 is an IMU. The IMU is mainly composed of an accelerometer and a gyroscope. The accelerometer is used to measure the linear acceleration of the object in three orthogonal directions. By integrating the acceleration, the velocity change and displacement of the object may be obtained. The gyroscope measures the angular velocity of the object around three orthogonal axes. By integrating the angular velocity, the angular change of the object may be obtained. When the object moves, the accelerometer and the gyroscope continue to work and generate corresponding acceleration and angular velocity signals. After these signals are processed and calculated, information such as the posture, velocity, and position of the object may be obtained in real time.

In some examples, the data from the second sensor 108 comprises angular velocity, acceleration, and angular acceleration of the IMU. The calibration parameters of the multiple first sensors (102-1, 102-2, . . . , 102-N) and the second sensor 108 comprise multiple translation matrices of the multiple lidars converted to the IMU coordinate system, multiple rotation matrices of the multiple lidars converted to the IMU coordinate system, a gyroscope bias of the IMU, an accelerometer bias of the IMU, a time offset of the IMU relative to the multiple lidars, and a gravity vector.

In this way, the simultaneous calibration of multiple mixed-type sensors is achieved, the accuracy and consistency of the data obtained from the multiple sensors are improved, and the time required for the calibration process is shortened. In addition, since the time offset of the second sensor 108 relative to the multiple first sensors (102-1, 102-2, . . . , 102-N) is also determined, the issue of not being able to calibrate temporal and spatial extrinsic parameters at the same time is overcome.

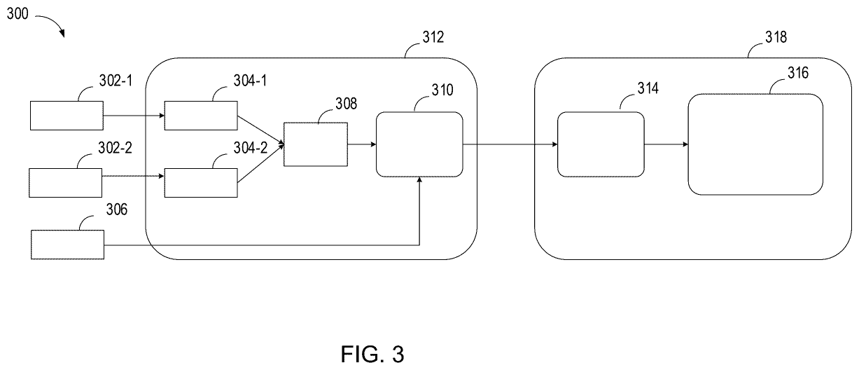

FIG. 3 is a schematic diagram of an example 300 of determining calibration parameters of a sensor according to some examples of the present disclosure. As shown in FIG. 3, the environment of example 300 comprises a lidar 302-1, a lidar 302-2, an IMU 306, a first stage module 312, and a second stage module 318. The first stage module 312 comprises a lidar odometer 304-1, a lidar odometer 304-2, a measurement noise attenuation module 308, and a first parameter calibration module 310. The second stage module 318 comprises a time-space optimization module 314 and a second parameter calibration module 316.

In example 300, lidar 302-1 and lidar 302-2 transmit the point cloud data scanned at different times to the lidar odometers 304-1 and 304-2 corresponding to them respectively, and the lidar odometers 304-1 and 304-2 obtain the angular velocities, accelerations and angular accelerations of the lidar 302-1 and the lidar 302-2 respectively through calculation. This approach ensures that even if the overlapping field of view between the lidar 302-1 and the lidar 302-2 is very narrow, calibrating the extrinsic parameters remains straightforward. By utilizing the odometer data from the lidar odometers 304-1 and 304-2, the use of the overlapping field of view is avoided, thereby enhancing practicality and applicability across various operating environments.

In example 300, the lidar odometers 304-1 and 304-2 transmit the odometer data of the lidars 302-1 and 302-2 to the measurement noise attenuation module 308. The measurement noise attenuation module 308 reduces the noise portion in the odometer data (angular velocities, accelerations, and angular accelerations of the lidar 302-1 and the lidar 302-2, respectively) by adopting an appropriate noise attenuation method (e.g., filtering, smoothing) to facilitate subsequent calculations.

In example 300, the first parameter calibration module 310 calculates the first calibration parameters using an optimization function for determining the first calibration parameters (i.e., Expression (1), which is established by the angular velocities in the odometer data of multiple lidars, the angular velocities and angular accelerations of the inertance measurement unit, and the first calibration parameters) and the odometer data from the measurement noise attenuation module 308 and the data from the IMU (the data from which the noise has been removed, comprising the angular velocity, acceleration and angular acceleration of the IMU 306). The first calibration parameters comprise two rotation matrices of the lidars 302-1 and 302-2 converted to the IMU 306 coordinate system, the gyroscope bias of the IMU 306, and the time offset of the IMU relative to the lidars 302-1 and 302-2 (the lidars 302-1 and 302-2 are time synchronized and there is no time offset). The optimization function may be expressed as

$$\begin{matrix}arg min \\ {R}_{L 0}^{I} , {R}_{L 1}^{I} , {b}_{w} , {δ}_{t}\end{matrix} \sum {‖ {R}_{L 0}^{I} {w}_{L 0} + {R}_{L 1}^{I} {w}_{L 1} + 2 {b}_{w} - 2 {w}_{I} - 2 {δ}_{t} {Ω}_{I} ‖}^{2} \qquad ( 1 )$$

wherein, argmin is the abbreviation of argument minimal, which means finding the parameter that makes the function in Expression (1) (the part on the right side of the summation symbol [including the summation symbol]) reach the minimum value,

$${R}_{L 0}^{I} and {R}_{L 1}^{I}$$

respectively represent the rotation matrices of the lidars 302-1 and 302-2 converted to the IMU 306 coordinate system, w_{L0} and w_{L1} respectively represent the angular velocity of the lidars 302-1 and 302-2, b_{w} represents the gyroscope bias of the IMU 306, w_{I} represents the angular velocity of the IMU 306, δₜ represents the time offset of IMU 306 relative to the lidars 302-1 and 302-2, and Ω_{I} represents the angular acceleration of IMU 306.

In order to determine the parameters

$${R}_{L 0}^{I} , {R}_{L 1}^{I} ,$$

b_{w} and δₜ that minimize the function in Expression (1), the initial values of

$${R}_{L 0}^{I} and {R}_{L 1}^{I}$$

are assigned to the identity matrix of 3 rows and 3 columns, the initial value of b_{w} is assigned to the zero vector of 3 rows and 1 column, and the initial value of δₜ is assigned to 0, and the solver for optimizing extrinsic parameters is used to optimize the function in Expression (1) in an iterative manner to find the solution

$$( {R}_{L 0}^{I} , {R}_{L 1}^{I} , {b}_{w} , {δ}_{t} )$$

that minimizes the function value in Expression (1). The solver for optimizing extrinsic parameters may include Ceres solver, G2O (general graph optimization) solver, NLopt (nonlinear optimization) solver, IPOPT (interior point optimizer) solver, optimization module in Eigen library, etc., and the appropriate solver may be selected according to the application scenario.

In example 300, the first parameter calibration module 310 transmits the first calibration parameters

$$( {R}_{L 0}^{I} , {R}_{L 1}^{I} , {b}_{w} , {δ}_{t} )$$

by solving the function in Expression (1), the odometer data from the measurement noise attenuation module 308 (the angular velocity, acceleration and angular acceleration of each of the lidars 302-1 and 302-2), and the data from the IMU 306 (comprising the angular velocity, acceleration and angular acceleration of the IMU 306) to the time-space optimization module 314 in the second stage module 318.

In some examples, the frame rate (the amount of data acquired per second) of the scanning data of the lidars 302-1 and 302-2 is usually lower than the frame rate of the measurement data of the IMU 306, which results in the odometer data from the measurement noise attenuation module 308 having an amount of data per second that is not equal to the amount of data collected by the IMU 306 per second. Therefore, the odometer data from the measurement noise attenuation module 308 needs to be processed so that the amount of data per second of the odometer data from the measurement noise attenuation module 308 is equal to the amount of data collected by the IMU 306 per second, thereby achieving time and space optimization of data from multiple (same or different) sensors and ensuring data consistency. This processing may comprise interpolation optimization of the odometer data from the measurement noise attenuation module 308. The interpolation methods include linear interpolation (simple calculation but relatively low accuracy), polynomial interpolation (higher accuracy), spline interpolation (can better fit the data while ensuring a certain smoothness), piecewise interpolation (better local accuracy, can avoid global error accumulation), etc. The appropriate interpolation method may be selected according to the characteristics of the data related to the lidars 302-1 and 302-2.

In the second stage module 318, the second parameter calibration module 316 calculates the second calibration parameters using the optimization function for determining the second calibration parameters (i.e., Expression (2), which is established by the angular velocities, angular accelerations, accelerations of the multiple lidars, and the multiple rotation matrices of the multiple lidars converted to the inertance measurement unit coordinate system) and the data from the time-space optimization module 314. The data from the time-space optimization module 314 comprises the first calibration parameters

$$( {R}_{L 0}^{I} , {R}_{L 1}^{I} , {b}_{w} , {δ}_{t} ) ,$$

velocity, acceleration and angular acceleration of each of the lidars 302-1 and 302-2, and the acceleration of the IMU 306. The second calibration parameters comprise two translation matrices of the lidars 302-1 and 302-2 converted to the IMU 306 coordinate system, the accelerometer bias of the IMU 306, and the gravity vector. The optimization function may be expressed as

$$( 2 )$$

$${argmin}_{{p}_{L 0}^{I} , {p}_{L 1}^{I} , {b}_{a} , g} \text{} \sum {‖ {R}_{I}^{L 0} ( {a}_{I} - {b}_{α} ) + {R}_{I}^{L 1} ( {a}_{I} - {b}_{α} ) - \text{} {a}_{L 0} - \text{} {a}_{L 1} - \text{} {⌊ {w}_{L 0} ⌋}_{∧}^{2} \cdot \\ {p}_{I}^{L 0} - {⌊ {w}_{L 1} ⌋}_{∧}^{2} \cdot {p}_{I}^{L 1} - {⌊ {Ω}_{L 0} ⌋}_{∧} \cdot {p}_{I}^{L 0} - {⌊ {Ω}_{L 1} ⌋}_{∧} {P}_{I}^{L 1} ‖}^{2}$$

wherein,

$${P}_{L 0}^{I} and {P}_{L 1}^{I}$$

represent the translation matrices of the lidars 302-1 and 302-2 converted to the IMU 306 coordinate system respectively, bₐ represents the bias of the accelerometer of the IMU 306, g represents the gravity vector, aᵢ represents the acceleration of the IMU 306, a_{L0} and a_{L1} represent the accelerations of the lidars 302-1 and 302-2 respectively,

$${R}_{I}^{L 0} and {R}_{I}^{L 1}$$

represent the rotation matrices of the IMU 306 converted to the lidar 302-1 coordinate system and the lidar 302-2 coordinate system respectively (which may be obtained according to

$${R}_{L 0}^{I} and {R}_{L 1}^{I} ) , {P}_{I}^{L 0} and {P}_{I}^{L 1}$$

represent the translation matrices of IMU 306 converted to the lidar 302-1 coordinate system and the lidar 302-2 coordinate system respectively, and Ω_{L0} and Ω_{L0} represent the angular accelerations of the lidars 302-1 and 302-2, respectively.

In order to determine the parameters

$${P}_{L 0}^{I} , {P}_{L 1}^{I} ,$$

bₐ and g that minimize the function in Expression (2) (the part on the right side of the summation symbol [including the summation symbol]), the initial values of

$${P}_{L 0}^{I} and {P}_{L 1}^{I}$$

are assigned to the identity matrix of 3 rows and 3 columns, the initial value of bₐ is assigned to the zero vector of 3 rows and 1 column, and the initial value of g is assigned to 0, and the solver for optimizing extrinsic parameters is used to optimize the function in Expression (2) in an iterative manner to find the solution

$$( {P}_{L 0}^{I} , {P}_{L 1}^{I} , {b}_{a} , g )$$

that minimizes the function value in Expression (2). The solver for optimizing extrinsic parameters may include Ceres solver, G2O solver, NLopt solver, IPOPT solver, optimization module in Eigen library, etc., and the appropriate solver may be selected according to the application scenario.

In some examples, there are multiple lidars and multiple IMUs. If the extrinsic parameter calibration among the multiple IMUs has been completed, it is only necessary to perform the extrinsic parameter calibration between the multiple lidars and a single IMU. There is no need to perform the extrinsic parameter calibration among the multiple lidars. In this way, the accumulation of calibration errors may be avoided, making the calibration more accurate. The method for performing extrinsic parameter calibration between multiple lidars and a single IMU may be derived by appropriately extending the aforementioned method. For example, if there are three lidars, add the

$${R}_{L 2}^{I} {w}_{L 2}$$

term to the square of the modulus in Expression (1), add the

$${{R}_{I}^{L 2} {a}_{I} - {a}_{L 2} - {⌊ {w}_{L 2} ⌋}_{∧}^{2} \cdot {P}_{I}^{L 2} - ⌋ {Ω}_{L 2} ⌋}_{∧} \cdot {P}_{I}^{L 2}$$

term to the square of the modulus in Expression (2), and so on. This approach allows the method of the examples of the present disclosure to be extended to scenarios involving more sensors, thereby demonstrating strong applicability and versatility.

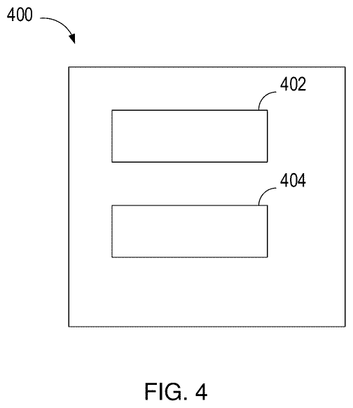

FIG. 4 is a schematic diagram of an apparatus 400 for determining calibration parameters of a sensor according to some examples of the present disclosure. As shown in FIG. 4, the apparatus 400 comprises an odometer data determination unit 402 and a calibration parameter determination unit 404, wherein the odometer data determination unit 402 is configured to determine the odometer data of multiple first sensors based on the data of multiple first sensors, and the calibration parameter determination unit 404 is configured to determine the calibration parameters of multiple first sensors and a second sensor based on the odometer data of the multiple first sensors and the data of the second sensor, wherein the first sensor and the second sensor are sensors of different types.

In some examples, the odometer data determination unit 402 comprises multiple first sensor odometers, which are configured to obtain data from the multiple first sensors and calculate the odometer data (e.g., position, displacement, speed, posture, etc.) of the multiple first sensors.

In some examples, the calibration parameter determination unit 404 comprises a first parameter calibration unit, which is configured to determine first calibration parameters based on the odometer data of the multiple first sensors and the data of the second sensor. The first calibration parameters comprise multiple rotation matrices of the multiple first sensors converted to the second sensor coordinate system, first calibration parameters associated with the second sensor, and a time offset of the second sensor relative to the multiple first sensors.

In some examples, the calibration parameter determination unit 404 further comprises a second parameter calibration unit, which is configured to determine second calibration parameters based on the first calibration parameters, the odometer data of the multiple first sensors, and the data of the second sensor. The second calibration parameters comprise multiple translation matrices of the multiple first sensors converted to the second sensor coordinate system, second calibration parameters associated with the second sensor, and a gravity vector.

In some examples, the calibration parameter determination unit 404 may further comprise a measurement noise attenuation unit and a time-space optimization unit. The measurement noise attenuation unit is configured to perform noise attenuation on the data before the data enters the first parameter calibration unit. The time-space optimization unit is configured to perform consistency processing on the data before the data enters the second parameter calibration unit, and the consistency processing comprises interpolating the data so that the data from multiple sensors match each other for calculation.

In some examples, the first sensor is a lidar, the second sensor is an IMU, the first sensor odometer is a lidar odometer, and the first calibration parameters comprise multiple rotation matrices of the multiple lidars converted to the IMU coordinate system, the gyroscope bias of the IMU, and the time offset of the IMU relative to the multiple lidars. The second calibration parameters comprise multiple translation matrices of the multiple lidars converted to the IMU coordinate system, the accelerometer bias of the IMU, and the gravity vector.

In some examples, the first calibration parameters and the second calibration parameters determined by the examples of the present disclosure may be used to perform three-dimensional reconstruction of images obtained by sensors (such as cameras, radars, lidars, etc.). For example, the first calibration parameters and the second calibration parameters may be used to accurately fuse the data obtained by the lidars (e.g., point cloud data, etc.) with the data obtained by the IMU (e.g., acceleration, angular velocity, etc.), thereby obtaining more accurate posture information and optimizing the registration of the point cloud, and then generating a three-dimensional model based on the posture information and the point cloud data.

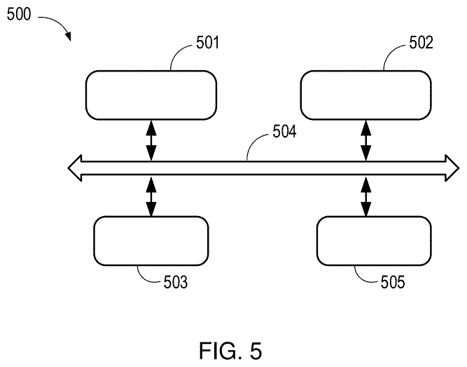

FIG. 5 is a block diagram of a controller 500 that may implement multiple examples of the present disclosure. The controller 500, for example, may be the environment 100 as shown in FIG. 1. As shown in the figure, the controller 500 comprises a processor 501, which can perform various appropriate actions and processes according to computer program instructions stored in a read-only memory (ROM) 502 and loaded into a random-access memory (RAM) 503. Various programs and data required for the operation of the controller 500 may also be stored in the RAM 503. The processor 501, the ROM 502, and the RAM 503 are interconnected through a bus 504. An input/output (I/O) interface 505 is also connected to the bus 504.

The processor 501 can be various general-purpose and/or special-purpose processing components with processing and computing capabilities. Examples of the processor 501 include, but are not limited to, central processing units (CPU), graphics processing units (GPU), various dedicated artificial intelligence (AI) computing chips, various computing units running machine learning model algorithms, digital signal processors (DSP), and any appropriate processors, controllers, microcontrollers, etc. The processor 501 performs various methods and processes described above, such as the method 200. For example, in some examples, the method 200 can be implemented as a computer software program tangibly contained in a machine-readable medium. In some examples, part or all of the computer programs may be loaded and/or installed onto the controller 500 through the ROM 502. When the computer program is loaded into the RAM 503 and executed by the processor 501, one or more steps of the method 200 described above can be performed. Alternatively, in other examples, the processor 501 may be configured to perform method 200 by any other suitable way (e.g., by way of firmware).

The functions described above herein can be performed, at least in part, by one or more hardware logic components. For example, and without limitation, exemplary types of hardware logic components that can be used comprise: Field Programmable Gate Arrays (FPGA), Application Specific Integrated Circuits (ASIC), Application Specific Standard Products (ASSP), System on a Chip (SOC), Complex Programmable Logic Devices (CPLD), and the like.

The program code for implementing the methods of the present disclosure can be written in any combination of one or more programming languages. This program code can be provided to a processor or controller of a general-purpose computer, special-purpose computer, or other programmable data processing devices such that the program code, when executed by the processor or controller, causes the functions/operations specified in the flowcharts and/or block diagrams to be implemented. The program code can be executed entirely on the machine, partly on the machine, as a stand-alone software package partly on the machine and partly on a remote machine, or entirely on a remote machine or server.

In the context of the present disclosure, a machine-readable medium can be a tangible medium that can contain or store programs for use by or in conjunction with an instruction execution system, apparatus, or device. A machine-readable medium can be a machine-readable signal medium or a machine-readable storage medium. The machine-readable medium can comprise, but is not limited to, electronic, magnetic, optical, electromagnetic, infrared, or semiconductor systems, apparatuses, or devices, or any suitable combination of the foregoing. More specific examples of the machine-readable storage medium would comprise electrical connections based on one or more wires, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing. Furthermore, although operations have been depicted in a specific order, it should be understood that such operations are not required to be performed in the specific order shown or in sequential order, nor are all illustrated operations required to be performed to achieve the desired results. In certain contexts, multitasking and parallel processing may be advantageous. Similarly, although several specific implementation details are included in the above discussion, these should not be construed as limiting the scope of the present disclosure. Certain features described in the context of separate examples can also be implemented in combination in a single implementation. Conversely, various features described in the context of a single implementation can also be implemented separately or in any suitable sub-combination in multiple implementations.

Although the subject matter has been described in language specific to structural features and/or methodological acts, it is to be understood that the subject matter defined in the appended Claims is not necessarily limited to the specific features or acts described above. Rather, the specific features and operations described above are merely exemplary forms of implementing the Claims.

What is claimed is:

1. A method for determining calibration parameters of a sensor, comprising:
determining odometer data of multiple first sensors based on data of the multiple first sensors; and
determining calibration parameters of the multiple first sensors and a second sensor based on the odometer data of the multiple first sensors and data of the second sensor, wherein the first sensor and the second sensor are sensors of different types.

2. The method according to claim 1, wherein the multiple first sensors are multiple lidars, the second sensor is an inertance measurement unit, and determining calibration parameters of the multiple first sensors and the second sensor comprises:
determining first calibration parameters of the multiple lidars and the inertance measurement unit;
determining second calibration parameters of the multiple lidars and the inertance measurement unit; and
determining the calibration parameters based on the first calibration parameters and the second calibration parameters.

3. The method according to claim 2, wherein determining the first calibration parameters of the multiple lidars and the inertance measurement unit comprises:
determining the first calibration parameters based on the angular velocities in the odometer data of the multiple lidars, and the angular velocities and angular accelerations of the inertance measurement unit.

4. The method according to claim 3, wherein determining the first calibration parameter comprises:
setting initial values of the first calibration parameters;
substituting the initial values of the first calibration parameters into an optimization function, wherein the optimization function is established by the angular velocities in the odometer data of the multiple lidars, the angular velocities and the angular accelerations of the inertance measurement unit and the first calibration parameters; and
determining the first calibration parameters that minimize the optimization function in an iterative manner.

5. The method according to claim 3, wherein determining the first calibration parameter comprises:
determining multiple rotation matrices of the multiple lidars converted to the inertance measurement unit coordinate system;
determining the gyroscope bias of the inertance measurement unit; and
determining the time offset of the inertance measurement unit relative to the multiple lidars.

6. The method according to claim 2, wherein determining the second calibration parameters of the multiple lidars and the inertance measurement unit comprises:
processing the odometer data of the multiple lidars so that the amount of data of the odometer data per second is equal to the amount of data sent per second by the inertance measurement unit; and
determining the second calibration parameters based on the processed odometer data of the multiple lidars, the accelerations of the inertance measurement unit, and a portion of the first calibration parameters.

7. The method according to claim 6, wherein:
the processed odometer data of the multiple lidars comprise angular velocities, angular accelerations and accelerations of the multiple lidars; and
the portion of the parameters in the first calibration parameters comprises multiple rotation matrices of the multiple lidars converted to the inertance measurement unit system.

8. The method according to claim 6, wherein determining the second calibration parameter comprises:
setting initial values of the second calibration parameters;
substituting the initial values of the second calibration parameters into an optimization function, wherein the optimization function is established by the angular velocities, angular accelerations, accelerations of the multiple lidars, and the multiple rotation matrices of the multiple lidars converted to the inertance measurement unit coordinate system; and
determining the second calibration parameters that minimize the optimization function in an iterative manner.

9. The method according to claim 7, wherein determining the second calibration parameter comprises:
determining multiple translation matrices of the multiple lidars converted to the inertance measurement unit coordinate system; and
determining the accelerometer bias and gravity vector of the inertance measurement unit.

10. The method according to claim 1, further comprising:
performing three-dimensional reconstruction of the image based on the calibration parameters of the multiple first sensors and the second sensor.

11. An apparatus for determining calibration parameters, comprising:
an odometer data determination unit configured to determine odometer data of multiple first sensors based on data of the multiple first sensors; and
a calibration parameter determination unit configured to determine calibration parameters of the multiple first sensors and a second sensor based on odometer data of the multiple first sensors and data of the second sensor, wherein the first sensor and the second sensor are sensors of different types.

12. A controller, comprising:
at least one processor; and
a memory coupled to the at least one processor and having instructions stored thereon, the instructions, when executed by the at least one processor, causing the controller to perform the method according to claim 1.

13. A computer program product, comprising a computer program, wherein the computer program is executed by a processor to implement the method according to claim 1.
